(19) United States
(12) Patent Application Publication
(10) Pub. No.: US 2014/0210589 A1
(43) Pub. Date: Jul. 31, 2014

(54) SMART CARD AND SMART SYSTEM WITH ENHANCED SECURITY FEATURES

(71) Applicant: MARY ADELE GRACE, BOULDER, CO (US)

(72) Inventor: MARY ADELE GRACE, BOULDER, CO (US)

(21) Appl. No.: 14/167,341

(22) Filed: Jan. 29, 2014

Related U.S. Application Data
(60) Provisional application No. 61/758,107, filed on Jan. 29, 2013.

(51) Int. Cl. G06F 21/32

(52) U.S. Cl. CPC G06F 21/32
USPC 340/5.51

(57) ABSTRACT

A smart card includes a fingerprint sensor/scanner which matches and verifies a person's identity against an on-board stored fingerprint template. If the identity is verified, the card will permit access to information stored on the card. All of the matching, templates and secure information are stored on the card. The smart card may also contain an NFC router which enables information on the card to be read wirelessly by enabled mobile phones. The smart card may be read by contact or wirelessly by standard smart card readers. No other smart card can communicate wirelessly with mobile phones, without an external reader.

### CLAIM OF BENEFIT TO PRIOR APPLICATION

This application claims benefit to U.S. Provisional Patent Application 61/758,107, entitled “Smart Card and Smart Card System With Enhanced Security Features,” filed Jan. 29, 2013. The U.S. Provisional Patent Application 61/758,107 is incorporated herein by reference.

### BACKGROUND

The embodiments herein relate generally to smart card systems, and more particularly to security and validation of smart card usage in smart card systems.

Credit cards, debit or bank cards, identification cards, reward cards, and any other of a variety of plastic cards that a person may carry or use have information encoded into the cards to facilitate their use. Many of these conventional cards may now be read without having to contact the card directly. In other words, when the cards are placed in proximity to a reader, the reader may be able to query the information stored on the card and extract the information needed to complete a transaction or other activity. The ability to access these cards without needing to physically touch the cards has led to many instances of identity theft or information theft by persons illicitly bringing a remote card reader or scanner within range of an unsuspecting cardholder.

In addition, it is possible to have physical contact with the cards and to use the contact to grab information from the card when the cardholder does not intend to have the information be transferred.

Conventional cards do not have protections against these types of intrusions. While cards may be shielded from radio sources that may try to grab information and may be protected from contact with a card reader, if either of these information grabbing avenues come into contact with the card, they may be able to grab information from the card without the cardholder's consent. Conventional approaches to enhanced card security, both physical and electronic, have involved unwanted hindrance to the desired convenient use of the card by the cardholder.

It is desirable to have additional security features that will protect the information stored on the card without unnecessarily hindering the ability of a cardholder to make use of the card for legitimate and desired transactions.

### BRIEF SUMMARY

The present disclosure relates to an improved card and card security system that may provide enhanced security features without undesirably hindering the easy use of the card by a cardholder. The card of the present disclosure may be effective in addressing the problems of: identity theft; ID and payment, debit, credit card fraud and theft; illegal physical and logical access; and may deny and prevent unauthorized access to and unauthorized removal of information from databases and confidential electronic and physical information and e-mails that may be related to information contained on the card.

Some embodiments of the invention provide a secure self-authenticating smart card that includes a card access module with securely stored information which is needed to use the smart card, a biometric module that verifies a person's identity before the card access module is allowed to access the securely stored information, and a power source. In some embodiments, the biometric module receives a biometric input from the person which is compared to a biometric template stored in a storage device of the smart card.

In some embodiments, the card access module comprises a secure element and a near field communication (NFC) router and the biometric module comprises a biometric sensor and a biometric processor. In some embodiments, the NFC router enables information on the smart card to be read wirelessly by enabled mobile devices. The smart card may be read by contact or wirelessly by standard smart card readers. No other smart card can communicate wirelessly with mobile devices, without an external reader.

In some embodiments, the biometric template is a fingerprint template, the biometric sensor is a fingerprint image sensor that scans a fingerprint of the person, and the biometric processor is a fingerprint processor that stores the fingerprint template and compares the person's fingerprint to the fingerprint template. The fingerprint processor, in some embodiments, is connected indirectly to the secure element through the NFC router. In some other embodiments, the fingerprint processor is connected directly to the secure element.

In some embodiments, the biometric module comprises a fingerprint image sensor but no fingerprint processor. In some of these embodiments, the secure element stores the fingerprint template and compares the person's fingerprint to the fingerprint template. In addition, the NFC router in some of these embodiments absorbs power from an attached antenna and supplies current to the secure element.

In some embodiments, the secure self-authenticating smart card comprises a secure element and a biometric sensor. The secure element is a dual interface smart card chip that provides current and clock to a fingerprint sensor and stores the fingerprint template and compares the person's fingerprint to the fingerprint template in some embodiments.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates an exterior view of a secure self-authenticating smart card in some embodiments.

FIG. 2 conceptually illustrates an architecture of a secure self-authenticating smart card in some embodiments.

FIG. 3 conceptually illustrates a timing diagram of a self-authenticating process of a secure smart card in some embodiments.

FIG. 4 conceptually illustrates another architecture of a secure self-authenticating smart card in some embodiments.

FIG. 5 conceptually illustrates an architecture of a secure self-authenticating smart card in some other embodiments.

FIG. 6 conceptually illustrates another architecture of a secure self-authenticating smart card in at least one embodiment.

FIG. 7 conceptually illustrates a block diagram of a secure self-authenticating smart card in at least one other embodiment.

FIG. 8 conceptually illustrates an electronic system with which some embodiments of the invention are implemented.

### DETAILED DESCRIPTION

In the following detailed description, several examples and embodiments of the invention are described. However, it will be clear to a person skilled in the art that the invention is not limited to the embodiments set forth and can be adapted for any of several other uses.

Some embodiments of the invention provide a secure self-authenticating smart card that includes a card access module with securely stored information which is needed to use the smart card, a biometric module that verifies a person's identity before the card access module is allowed to access the securely stored information, and a power source. In some embodiments, the biometric module receives a biometric input from the person which is compared to a biometric template stored in a storage device of the smart card.

By way of example, a secure self-authenticating smart card is shown in FIG. 1, which conceptually illustrates an exterior view of the smart card in some embodiments. Specifically, this figure shows a smart card 100 that has a card access module 110 and a biometric module 120. In this example, the biometric module is a fingerprint sensor/scanner. The finger of an exemplary user of the smart card 100 is shown on the fingerprint sensor 120. When the fingerprint matches a fingerprint template stored in the smart card 100, the information in the smart card will be unlocked for use. Thus, the user will be able to use the smart card only if the fingerprint can be matched. This security feature ensures that lost cards cannot be abused by unauthorized users because in order to access the information, programs, or other data items in the smart card, the smart card must first validate the user's identity.

The smart card 100 may incorporate a finger scanner or other biometric scanner into the biometric module 120 to provide a security feature that will prevent the access to or transmission of information held by the card unless an authorized person presents a prior-approved biometric feature, such as a fingerprint, to the scanner. For example, if the cardholder wishes to have a personal card which only the cardholder is authorized to use, the biometric scanner may be programmed to only recognize the biometric feature of the cardholder. Unless the cardholder presents the biometric feature to the scanner, the card will block any attempts to access the information encoded on the card. However, in some embodiments, a user or cardholder can submit the smart card to a terminal in advance through a self-authentication process in which the user or cardholder touches a finger onto the finger print scanner.

It is anticipated that more than one person's biometric features may be approved and that any person's biometric feature that is approved for the card may use the card once the proper biometric feature is presented to the scanner. Examples of biometric features that can be scanned include fingers, retinas, irises, faces, etc. Additionally, the finger print template and sample of authorized users may be securely kept in the smart card and processed entirely on board the smart card so that user privacy can be protected from privacy-abuse and misuse.

In some embodiments, the card access module comprises a secure element and a near field communication (NFC) router and the biometric module comprises a biometric sensor and a biometric processor. In some embodiments, the NFC router enables information on the smart card to be transmitted wirelessly and read by NFC-enabled mobile devices. The smart card may be read by contact or wirelessly by standard smart card readers. No conventional biometric verification smart cards exist which can communicate wirelessly with mobile phones. Also, no conventional smart cards which can communicate wirelessly with mobile phones, without an external reader.

In addition to the security feature enabled by the on-board scanner, it is anticipated that the smart card can also communicate directly via an NFC router in the card which enables the card to be read by mobile phones wirelessly, without an external reader. The addition of the security features may help prevent ID and payment fraud and theft over mobile phones. The card of the present disclosure may also be preferably readable wirelessly by standard smart card readers, once the access to information on the card has been authorized by the scanner, to provide enhanced security while still utilizing standard card readers.

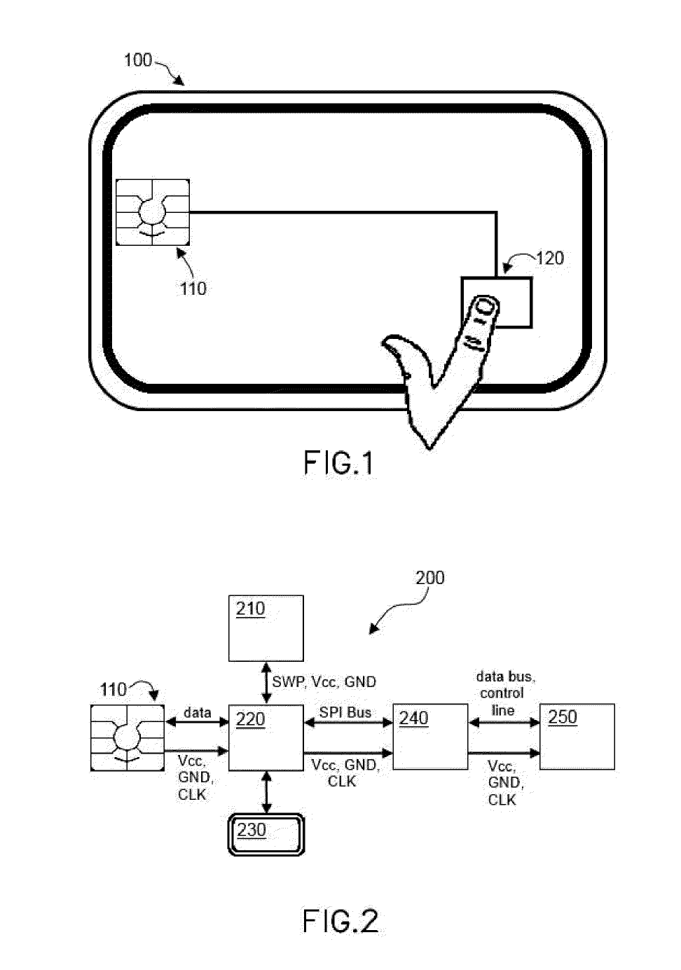

FIG. 2 conceptually illustrates an architecture 200 of a secure self-authenticating smart card in some embodiments. The card access module 110 in this figure is a security chip that may or may not be visible from the surface of the card. In other words, the security chip is a contact pad that allows the smart card to be accessed, for example, by a smart card reader or an application that emulates a smart card reader. In addition, the smart card in this figure includes a secure element 210 and an NFC router 220 with an antenna 230 that facilitates wireless communication between a terminal (e.g., a dedicated smart card reader device, a mobile device that is NFC-enabled and includes an application that can read the smart card, etc.) and the smart card.

The biometric module 120 described above by reference to FIG. 1 is represented in FIG. 2 as two separate integrated circuit (IC) chips, namely, a fingerprint processor 240 and a fingerprint sensor 250. In addition, the smart card architecture 200 illustrates communication and resource management with respect to any of a variety of information devices using any of a variety of standard protocols once the access to the information on the card is authorized by the biometric scanner. For instance, the smart card can communicate with external terminal using ISO7816 and ISO14443 protocol securely. Proprietary protocols may be used as well with the scope of the present disclosure. Nevertheless, data transfer and resource sharing (i.e., power, ground, clock, etc.) are dependent upon the finger of the authorized user(s) of the card, which when scanned by the fingerprint sensor 250 and matched by the fingerprint processor 240, will turn the card on and permit access to or communication of the information contained on the card. In contrast, the card will not work when an unauthorized person's finger is scanned.

In some embodiments, the biometric template is a fingerprint template, the biometric sensor is a fingerprint image sensor that scans a fingerprint of the person, and the biometric processor is a fingerprint processor that stores the fingerprint template and compares the person's fingerprint to the fingerprint template. The fingerprint processor, in some embodiments, is connected indirectly to the secure element through the NFC router. In some other embodiments, the fingerprint processor is connected directly to the secure element.

It is anticipated that secure self-authenticating smart cards according to the present disclosure may be used as access control cards to monitor and limit access by cardholders to secured access areas. It is further anticipated that cards according to the present disclosure may be used as financial payment and cash cards. Such cards may be used as medical information cards to securely and confidentially maintain the cardholder's critical, private, and other medical information. Cards according to the present disclosure may be used as combination cards, such as but not limited to, a combination government ID and payment card enabling a cardholder to receive all government and other payments on a single card. Cards according to the present disclosure may be used for accounting controls for all payments made in government agencies, companies, banks, and other entities. The cards may be used to account for transactions in real time by traders of securities, derivatives, etc., to identify traders and serve to hinder out-of-control, unauthorized, or insider trades. The present disclosure may permit the creation of transportation ID and payment cards for subways, buses, trains, planes, automobile and driver identification for transportation of hazardous goods and across border automobiles and transportation of goods and individuals.

The above examples of possible uses of the card according to the present disclosure are presented as illustrative only and are not intended to limit the possible uses of such cards. Notwithstanding the examples described by reference to FIGS. 1 and 2 above, the secure self-authenticating smart cards of some embodiments include the following exemplary elements. It is not intended that this be an exhaustive or exclusive list of components and this list is presented to provide an example embodiment of a card according to the present disclosure.

1. Secure Element

2. Security Chip

3. NFC Router

4. Passive Components

5. Fingerprint Processor

6. Fingerprint Image sensor

7. Antenna

8. Fingerprint Template

9. Power Control Device (PCD) Reader/Writer

10. Memory

11. Software

12. Algorithm

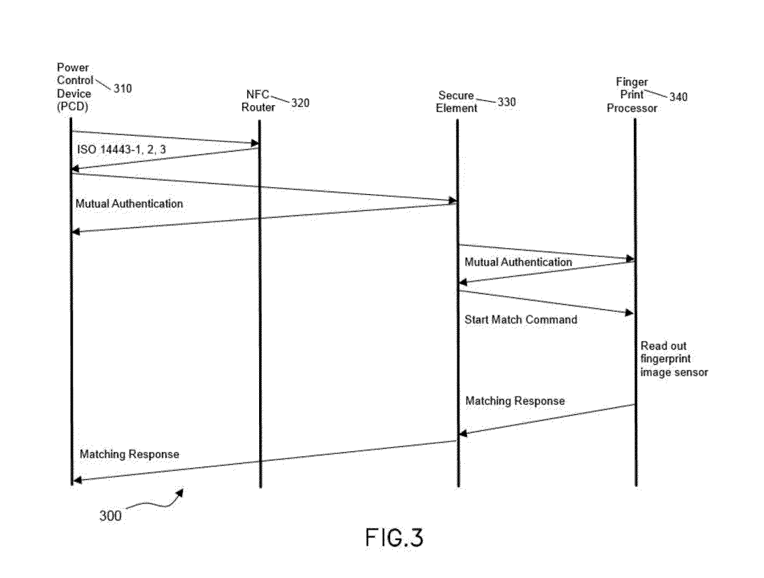

The various exemplary components are interrelated in ways that maintain overall operation of the associated secure smart card. To better understand the overall manner in which the different components of a secure smart card performs self-authentication through biometric identification matching, a timing diagram conceptually illustrated in FIG. 3 provides an example of events in an identity matching and verifying process which may be performed during usage of a smart card in some embodiments. As shown in this figure, an NFC router 320 regulates the power which is transferred from the power control device (PCD) 310 via the NFC antenna. The PCD 310 may also distribute power to the secure element 330 and the finger print processor 340. The NFC router 320 acts as a switch, in some embodiments, between the PCD reader/writer 310, the secure element 330 and the finger print processor 340.

The secure element 330 may process cryptographic computation, and process external authentication which is issued by external entities. The secure element 330 may cooperate with a memory device (e.g., EEPROM non-volatile persistent storage) to securely stores keys and data. For instance, the secure element may store private keys used in an asymmetric cryptographic system, such as RSA or DES. The secure element 330 may also process external authentication which may be issued by external entities attempting to access the card's information (e.g., via cryptographic token interface libraries and Cryptoki API calls).

The finger print processor 340 may be a secure microprocessor based unit that is configured to read-out finger print image data from the finger print image sensor and attempt to match image data with the finger print image templates that it stores to identify authorized users or cardholders. The finger print image sensor may be configured to grab or receive a finger print image at the request of the finger print processor 340 and may send back image data to be evaluated against the stored finger print image templates for authorized users or cardholders.

While the examples described above by reference to FIGS. 1-3 provide an overview of the secure self-authentication system of smart cards according to the present disclosure, the following examples of additional configurations and architectures highlight further aspects and details of the secure self-authenticating smart cards of some embodiments.

In particular, some embodiments of the secure smart card include a fingerprint sensor which matches and verifies the user's identity, which if successfully matched and verified, turns the smart card on so that the security chip on the smart card can communicate with external readers. In some of these embodiments, the operations for matching are performed by one or more programs embedded in the smart card.

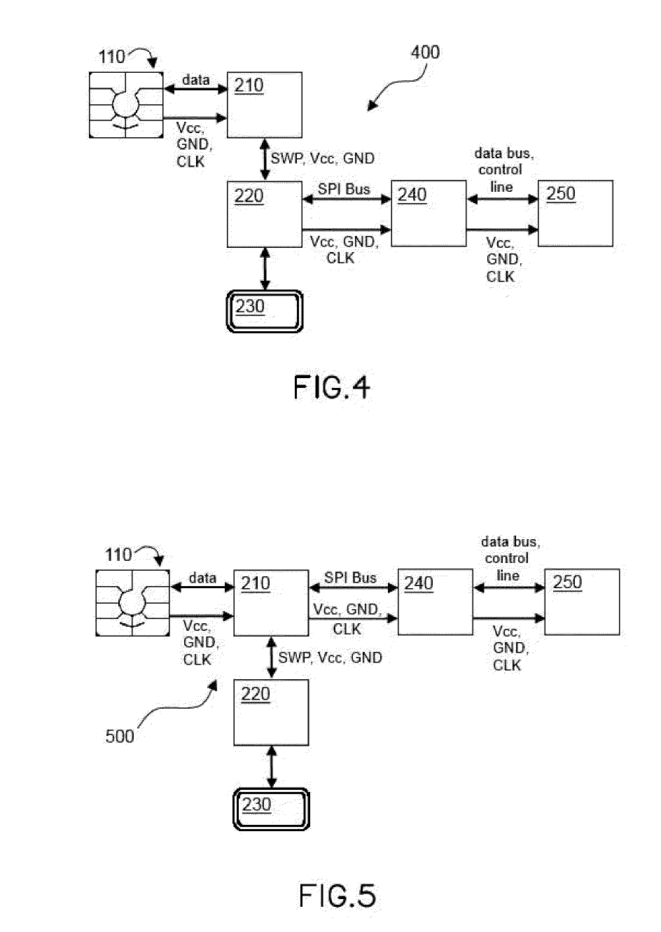

FIG. 4 conceptually illustrates an architecture 400 of a secure self-authenticating smart card in which a fingerprint sensor 250 receives a finger of the user to scan and the fingerprint processor 240 compares the captured image of the user's fingerprint to a stored template image of the fingerprint, and if successfully matched, indirectly turns on the smart card via the NFC router 220, thereby allowing the security chip 110 to communicate with external readers.

FIG. 5 conceptually illustrates another architecture 500 of a secure self-authenticating smart card in which the fingerprint processor 240 turns on the smart card via direct interface to the secure element 210.

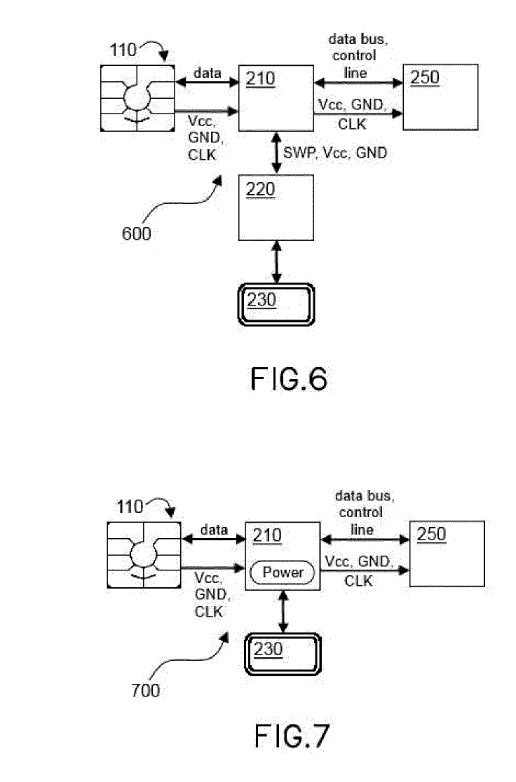

In some embodiments, a finger print sensor/scanner may be installed on a smart card which is connected to the secure element and the security chip located on same plastic body of the card. FIGS. 6 and 7 conceptually illustrate additional architectures 600 and 700 of secure self-authenticating smart cards in which the fingerprint sensor 250 is connected directly to the secure element 210 on the card. The example architecture 600 shown in FIG. 6 includes only three IC chips, specifically, the secure element 210, the NFC router 220, and the fingerprint sensor/scanner 250. In these embodiments, the secure element 210 performs fingerprint processing to match and verify the user's identity.

Also, as shown in FIG. 7, the fingerprint sensor/scanner 250 is in direct communication with the secure element. This configuration eliminates the NFC router because of the direct interface between the fingerprint sensor 250 and the secure element 210. This also provides great security in the transmission of fingerprint images and other smart card-stored information, which is completely encapsulated within the card during data transfer. Moreover, in the architecture 700 shown in FIG. 7, power derivation is a process on-board the secure element and is entirely derived from power sources which do not require batteries (e.g., induction).

In some embodiments, the smart card may be configured to operate in one or both of self-powered and battery-less manner. In particular, the power sources associated with the example architectures described by reference to FIGS. 4 and 5 are based on battery power. On the other hand, the power sources associated with the example architectures described by reference to FIGS. 6 and 7 are based on non-battery sources, such as induction. The smart card may also operate using power received from terminal vial ISO7816 pins and ISO14443 RF power.

To use the smart card according to the present disclosure, an authorized user or cardholder could utilize the card in one or more of the following manners: as a secure ID card, as a secure access card, for physical or logical access, as a secure payment card for debit or credit card by wirelessly holding the card near a mobile phone or a standard wireless smart card readers. A person could use the smart card with the fingerprint sensor to match and verify their identity which would then turn on the card so the security chip on the smart card can communicate with external readers to verify their identity. The matching is preferably all done on the card which may further protect privacy and security.

Further, a person might touch their registered finger to the finger print sensor/scanner is installed on smart card which may be connected to the smart element and the security chip located on same plastic body of the card.

Additionally, the smart card according to the present disclosure can be used in all fields requiring positive identification, such as but not limited to, driver's license, passports, medicare and social security payment and all government identification cards and payments, in all fields of access, in all fields of payments, in verification of traders and number of trades on trading platforms, and securities, and it could be used secure computer and database access and control and prevent hacking and/or unauthorized access and removal of information. The smart card of the present disclosure may be used as one of many different types of access control cards, many different types of financial payment and cash cards, many different types of medical ID cards with users critical and other medical information, combination cards, such as but not limited to government ID and payment cards enabling user to receive all government and other payments on their cards. The smart card could be used as accounting controls for all payments made in government agencies, companies and banks

The smart card of some embodiments may conform to one or more standards from the the following non-exhaustive list of standards:

ISO/IEC 7816

ISO/IEC 14443

ISO18092

NFC Forum defined standards

EMV

VisaWave, PayPass

FIPS140-1, 2, 3

FIPS121

GlobalPlatform

JavaCard

While several embodiments of the invention have been described by reference to one or more figures, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention.

Also, some of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors or other processing units), they cause the processing unit(s) to perform the actions indicated in the instructions. Examples of computer readable media include, but are not limited to, CD-ROMs, flash drives, RAM, hard drives, EPROMs, EEPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

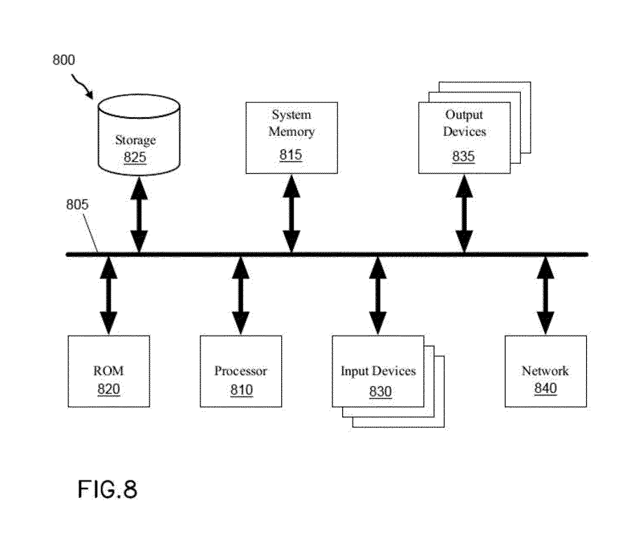

FIG. 8 conceptually illustrates an electronic system 800 with which some embodiments of the invention are implemented. The electronic system 800 may be a computer, phone, PDA, or any other sort of electronic device. Such an electronic system includes various types of computer readable media and interfaces for various other types of computer readable media. Electronic system 800 includes a bus 805, processing unit(s) 810, a system memory 815, a read-only 820, a permanent storage device 825, input devices 830, output devices 835, and a network 840.

The bus 805 collectively represents all system, peripheral, and chipset buses that communicatively connect the numerous internal devices of the electronic system 800. For instance, the bus 805 communicatively connects the processing unit(s) 810 with the read-only 820, the system memory 815, and the permanent storage device 825.

From these various memory units, the processing unit(s) 810 retrieves instructions to execute and data to process in order to execute the processes of the invention. The processing unit(s) may be a single processor or a multi-core processor in different embodiments.

The read-only-memory (ROM) 820 stores static data and instructions that are needed by the processing unit(s) 810 and other modules of the electronic system. The permanent storage device 825, on the other hand, is a read-and-write memory device. This device is a non-volatile memory unit that stores instructions and data even when the electronic system 800 is off. Some embodiments of the invention use a mass-storage device (such as a magnetic or optical disk and its corresponding disk drive) as the permanent storage device 825.

Other embodiments use a removable storage device (such as a floppy disk or a flash drive) as the permanent storage device 825. Like the permanent storage device 825, the system memory 815 is a read-and-write memory device. However, unlike storage device 825, the system memory 815 is a volatile read-and-write memory, such as a random access memory. The system memory 815 stores some of the instructions and data that the processor needs at runtime. In some embodiments, the invention's processes are stored in the system memory 815, the permanent storage device 825, and/or the read-only 820. For example, the various memory units include instructions for processing appearance alterations of displayable characters in accordance with some embodiments. From these various memory units, the processing unit(s) 810 retrieves instructions to execute and data to process in order to execute the processes of some embodiments.

The bus 805 also connects to the input and output devices 830 and 835. The input devices enable the user to communicate information and select commands to the electronic system. The input devices 830 include alphanumeric keyboards and pointing devices (also called “cursor control devices”). The output devices 835 display images generated by the electronic system 800. The output devices 835 include printers and display devices, such as cathode ray tubes (CRT) or liquid crystal displays (LCD). Some embodiments include devices such as a touchscreen that functions as both input and output devices.

Finally, as shown in FIG. 8, bus 805 also couples electronic system 800 to a network 840 through a network adapter (not shown). In this manner, the computer can be a part of a network of computers (such as a local area network (“LAN”), a wide area network (“WAN”), or an Intranet), or a network of networks (such as the Internet). Any or all components of electronic system 800 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details and examples, but rather is to be defined by the appended claims.

What is claimed is:

1. A smart card comprising:
a secure element;
a security chip;
a router;
a fingerprint processor;
a fingerprint image sensor;
an antenna;
at least one authorized fingerprint template;
a PCD reader/writer; and
software configured to receive a fingerprint image from the fingerprint image sensor and compare the fingerprint image to the at least one authorized fingerprint template and permit access to the secure element only if the fingerprint image matches one of the at least one authorized templates, without requiring access to any information or systems not on the card.

2. A non-transitory computer readable medium storing a program which when executed by at least one processing unit of a smart card verifies identity of a person attempting to access information stored on the smart card, said program comprising sets of instructions for:
scanning a finger to obtain a fingerprint image of a finger of the person;
capturing the fingerprint image of the scanned finger of the person;
securely retrieving a fingerprint template to compare to the captured fingerprint;
comparing a set of identifying marks of the fingerprint to a set of identifying marks of the fingerprint template; and
setting a lock property for access to information stored on the smart card, said lock property set to only one of unlocked and locked, wherein the lock property is set to unlocked when the set of identifying marks of the fingerprint match the set of identifying marks of the fingerprint template, wherein the lock property is set to locked when the set of identifying marks of the fingerprint fails to match the set of identifying marks of the fingerprint template.
